(19) United States
(12) Patent Application Publication
(10) Pub. No.: US 2016/0053797 A1
(43) Pub. Date: Feb. 25, 2016

(54) ASSEMBLIES AND METHODS FOR COUPLING COMPONENTS HAVING SLOTS AND/OR DEFORMABLE STAKES

(71) Applicant: Emerson Network Power, Energy Systems, North America, Inc., Warrenville, IL (US)

(72) Inventors: Simon Shen-Meng CHEN, Palatine, IL (US); Raymond A. MANN, Wellington, OH (US); Jerome A. MALONEY, Sugar Grove, IL (US)

(21) Appl. No.: 14/486,730

(22) Filed: Sep. 15, 2014

Related U.S. Application Data
(60) Provisional application No. 62/039,715, filed on Aug. 20, 2014.

(51) Int. Cl. F16B 19/04

(52) U.S. Cl. CPC F16B 19/04

(57) ABSTRACT

An assembly includes a first component having a surface and a deformable stake extending from the surface and defining a gap between the surface and the deformable stake, and a second component defining a slot configured to receive the deformable stake for coupling the first component and the second component. In some example embodiments, the gap is surrounded by the surface and the deformable stake. In other example embodiments, a width between legs of the deformable stake is greater than a width of the slot of the second component. In yet other example embodiments, the surface from which the deformable stake extends may be an edge surface.

### CROSS-REFERENCE TO RELATED APPLICATION

This application claims the benefit of U.S. Provisional Application No. 62/039,715 filed Aug. 20, 2014. The entire disclosure of the above application is incorporated herein by reference.

### FIELD

The present disclosure relates to assemblies and methods for coupling components having slots and/or deformable stakes.

### BACKGROUND

This section provides background information related to the present disclosure which is not necessarily prior art.

Shelves and other similar structures may be formed by coupling various walls together. Typically, the walls are coupled together with mechanical fasteners such as bolts, screws, rivets, brackets, etc. In some cases, the walls may be welded together. In other cases, a staking process may be employed to couple the walls together such that they extend in parallel planes.

### SUMMARY

This section provides a general summary of the disclosure, and is not a comprehensive disclosure of its full scope or all of its features.

According to one aspect of the present disclosure, an assembly includes a first component having a surface and a deformable stake extending from the surface and defining a gap between the surface and the deformable stake, and a second component defining a slot configured to receive the deformable stake for coupling the first component and the second component. The gap is surrounded by the surface and the deformable stake.

According to another aspect of the present disclosure, an assembly includes a first component including a deformable stake having a first leg, a second leg, and a roof extending between the first leg and the second leg, and a second component defining a slot having a width and configured to receive the deformable stake for coupling the first component and the second component. Each of the first leg and the second leg has an outside edge surface and an inside edge surface opposing the outside edge surface. A maximum width between the outside edge surface of the first leg and the outside edge surface the second leg is greater than the width of the slot of the second component.

According to yet another aspect of the present disclosure, an assembly includes a first component having at least two edge surfaces, an inner surface extending between the at least two edge surfaces, and a deformable stake extending from one of the at least two edge surfaces and defining a gap between said one edge surface and the deformable stake. The assembly further includes a second component defining a slot configured to receive the stake for coupling the first component and the second component.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross sectional view of an assembly including a portion of a component having a deformable stake and a portion of another component defining a slot for receiving the deformable stake according to one example embodiment of the present disclosure.

FIG. 2 is a cross sectional view of the assembly of FIG. 1 after crushing the deformable stake.

FIG. 3 is a side view of the component of FIG. 1 including multiple deformable stakes.

FIG. 4 is an enlarged side view of one deformable stake of FIG. 1.

FIG. 5 is a side view of a portion of a component including a deformable stake having a uniform thickness and extending from an edge surface of the component according to another example embodiment.

FIG. 6 is a side view of a portion of a component including a deformable stake having tapered legs and extending from an edge surface of the component according to yet another example embodiment.

FIG. 7 is a side view of a portion of a component including a deformable stake having varying thicknesses and extending from an edge surface of the component according to another example embodiment.

FIG. 8 is a side view of a portion of a component including a deformable stake extending from an edge surface of the component according to yet another example embodiment.

FIG. 9 is a side view of a component including a deformable stake having tapered legs and extending from a surface between edge surfaces of the component according to another example embodiment.

FIG. 10 is an isometric view of a component including a deformable stake having a uniform thickness and extending from a surface between edge surfaces of the component according to yet another example embodiment.

FIG. 11 is a cross sectional view of an assembly including a portion of a component having a deformable stake and a portion of another component defining a slot for receiving the deformable stake according to another example embodiment.

FIG. 12 is an isometric view of a shelf including walls having deformable stakes, a cover defining slots for receiving the deformable stakes, and a base defining slots for receiving the deformable stakes according to yet another example embodiment.

FIG. 13 is an exploded isometric view of the shelf of FIG. 12.

Corresponding reference numerals indicate corresponding parts or features throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

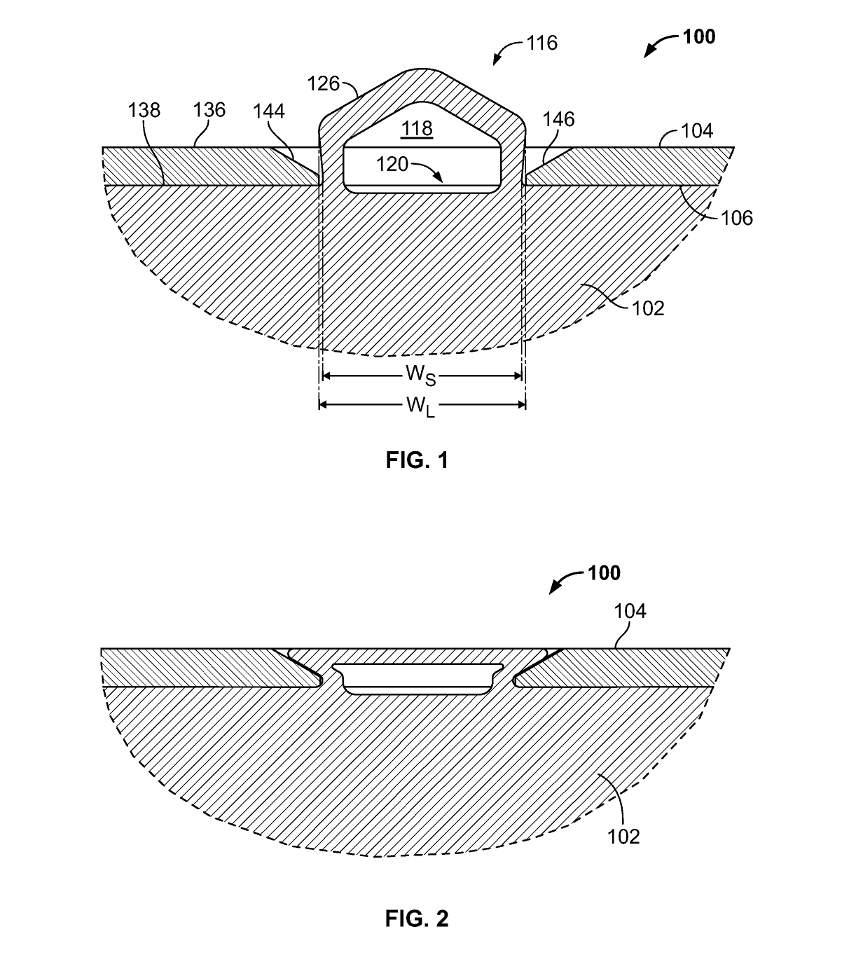

An assembly according to one example embodiment of the present disclosure is illustrated in FIGS. 1-4, and indicated generally by reference number 100. As shown in FIGS. 1-4, the assembly 100 includes components 102, 104. The component 102 has a surface and a deformable stake 116 extending from the surface and defining a gap 118 between the surface and the deformable stake 116. As shown in FIG. 1, the component 104 defines a slot 120 for receiving the deformable stake 116 for coupling the component 102 and the component 104.

As shown in FIGS. 1-4, the component 102 includes multiple surfaces 106, 108, 110, 112, 114 and the component 104 includes multiple surfaces 136, 138, 144, 146. In the example of FIGS. 1-4, the deformable stake 116 extends from the edge surfaces 106, 110. Additionally or alternatively, the deformable stake 116 may extend from one or more other surfaces, including the edge surface 108 and/or edge surface 112, the inner surface 114 (further explained below), the opposite inner surface (not shown), etc.

The gap 118 may be surrounded by a surface of the component 102 and the deformable stake 116. For example, the gap 118 of FIGS. 1 and 4 is surrounded by a portion of the surface 106 and the deformable stake 116. As such, the gap has a closed perimeter. By having the gap 118 surrounded by the deformable stake 116 and one or more surfaces of the component 102, the stake 116 may be crushed, deformed, etc. into the slot 120 without concern of the stake 116 bottoming out below a surface of the component 104. As such, separate stopping device(s) such as bucking bars or the like are not needed to ensure the stake 116 remains substantially flush with the component 104 after being crushed.

Alternatively, and as further explained above, the gap 118 may have an open perimeter. For example, the gap 118 may be defined by the deformable stake 116, portion(s) of a surface (e.g., the inner surface 114, etc.), etc.

In some embodiments, the gap 118 may be designed to ensure the stake 116 is substantially flush with the surface 136 of the component 104 after the stake 116 is crushed, etc. For example, the gap 118 may include particular dimensions (e.g., a height, an area, a volume, etc.), a closed perimeter, a partially closed perimeter, particular material(s), etc. to ensure the crushed stake 116 is substantially flush with the component 104

Additionally or alternatively, a width of the stake 116 may be greater than, less than, or equal to a width of the slot 120 of the component 104. For example, and as shown in FIGS. 1 and 4, the stake 116 includes legs 122, 124 and a roof 126 extending between the legs 122, 124. The legs 122, 124 each include an outside edge surface 128, 132 and an opposing inside edge surface 130, 134, respectively. As shown in FIG. 1, a width (WL) between the outside edge surface 128 of the leg 122 and the outside edge surface 132 of the leg 124 is greater than a width (WS) of the slot 120 of the component 104.

For example, the stake 116 may be forced into the slot 120 causing the stake 116 to deflect. After which, the stake 116 may expand (e.g., back to its original size, a size less than its original size, etc.) due to, for example, the stake's resiliency. Thus, by employing the above described optional feature, the stake 116 may be restricted from falling out of, exiting from, etc. the slot 120 before the stake 116 is crushed, etc. without requiring users, other components (e.g., clamps, etc.) to hold the stake 116 within the slot 120.

In some embodiments, the legs 122, 124 may be tapered. For example, and as shown in FIGS. 1 and 4, the legs 122, 124 may have a tapered portion extending from the roof 126 to the surface of the component 102. Put another way, the legs 122, 124 may taper towards the surface (from which they extend) of the component 102. Thus, and as shown in FIG. 4, a width (W1) between the outside edge surfaces 128, 132 adjacent the roof 126 is greater than a width (W2) between the outside edge surfaces 128, 132 adjacent the surface of the component 102. By employing this optional feature, the legs 122, 124 may collapse with greater ease relative to, for example, legs having a uniform thickness.

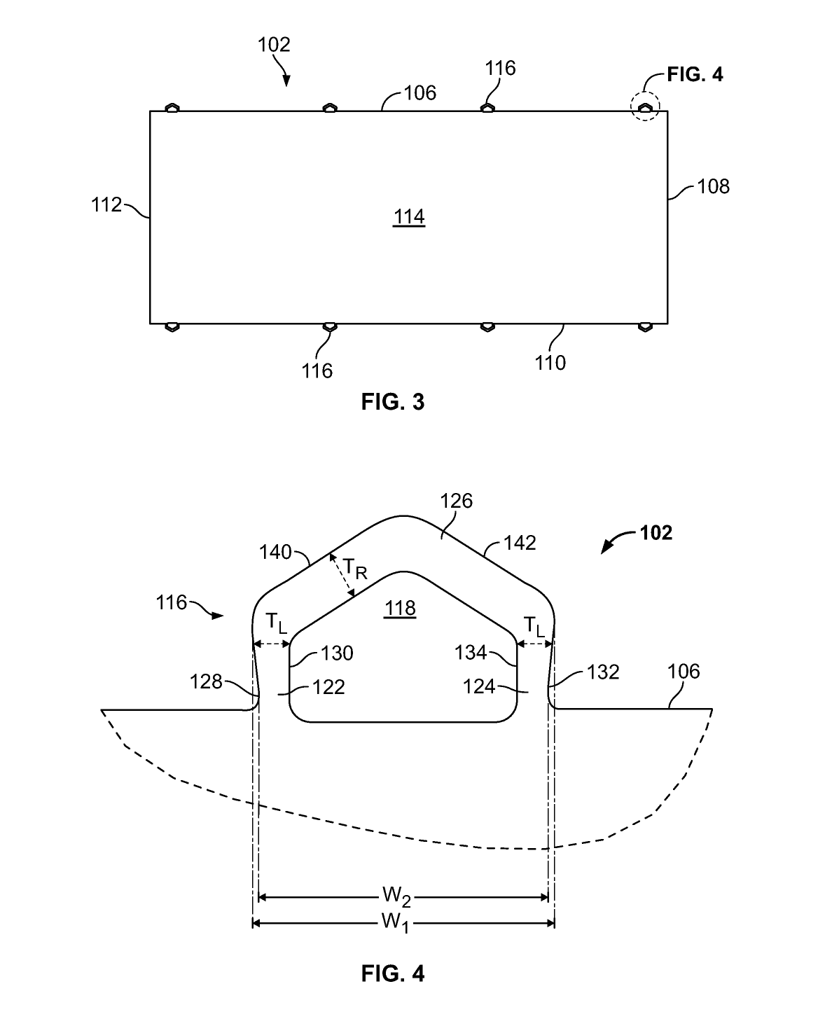

In the example embodiments including tapered legs (e.g., the legs 122, 124 of FIGS. 2 and 3, etc.), the width (WL) between the outside edge surface 128 of the leg 122 and the outside edge surface 132 of the leg 124 may be a maximum width between the legs 122, 124. Thus, in such cases, the maximum width between the outside edge of the leg 122 and the outside edge the leg 124 is greater than the width of the slot 120.

Additionally or alternatively, a roof of the stake may have a thickness greater than a thickness of at least one of the legs. For example, and as shown in FIG. 4, the roof 126 has a thickness (TR) greater than a thickness (TL) of each leg 122, 124. Additionally, if a stake includes tapered legs (e.g., the legs 122, 124 of FIGS. 1 and 4, etc.), the roof thickness (TR) may be greater than a maximum thickness of each leg 122, 124. In other embodiments, the roof thickness (TR) may be thicker than only one of the legs 122, 124, the roof and the legs may have a uniform thickness, the roof thickness (TR) may be thinner than one or both legs 122, 124, etc.

By employing this optional feature, the legs 122, 124 may fold, collapse, etc. when the stake 116 is crushed and the roof 126 of the crushed stake may remain substantially flush (e.g., prevented from bottoming out) with the component 104 as further explained below.

As shown in FIG. 1, the component 104 includes opposing inner surfaces 136, 138 and edge surfaces 144, 146 extending between the inner surfaces 136, 138. The inner surfaces 136, 138 include the slot 120 for receiving the deformable stake 116. Thus, in the example of FIGS. 1-4, when a stake 116 is inserted into a slot 120, the component 102 extends substantially perpendicular to the component 104. If, however, a stake extends from an inner surface (e.g., the inner surface 114, etc.) of the component 102, the planes would be substantially parallel to each other.

As shown in FIGS. 1 and 2, the slot 120 includes beveled portions. For example, the edge surfaces 144, 146 (which may also define the slot 120) include slanted portions extending downwardly toward a center portion of the slot 120. Thus, the slot 120 of the FIGS. 1 and 2 may be considered a beveled slot. These optional beveled portions may define additional space, area, etc. to accommodate, receive, etc. portions of the stake 116 (e.g., portions of the roof 126 and/or legs 122, 124) after the stake 116 is crushed.

Alternatively, the slot 120 may include one beveled portion (e.g., one slanted edge surface defining the slot 120), no beveled portions (as explained below), multiple beveled portions (e.g., one or more edge surface may include two or more slanted portions), different beveled portions (e.g., one or more edge surfaces defining the slot 120 may have slanted portions of different angles), etc.

When the deformable stake 116 is crushed, etc., the legs 122, 124 may fold, collapse, etc. outwardly toward the edge surfaces 144, 146 of the component 104. Additionally, the roof 126 may fold, collapse, cave into, etc. downwardly. Thus, and as shown in FIG. 2, after the stake 116 is deformed, the crushed legs 122, 124 (or portions thereof) and/or the crushed roof 126 (or portions thereof) abut against the edge surfaces 144, 146 of the component 104 to secure the crushed stake 116 within the slot 120. Additionally, the crushed legs 122, 124 (or portions thereof) and/or the crushed roof 126 (or portions thereof) may be substantially flush with the surface 136 of the component 104.

In the example shown in FIGS. 1 and 4, the gap 118 includes five sides. For example, interior facing edge surfaces 140, 142 of the roof 126, the inside edge surface 130 of the leg 122, the inside edge surface 134 of the leg 124, and a portion of a surface (e.g., the edge surface 106, etc.) of the component 102 define the five sides of the gap 118. In such examples, the gap 118 is a pentagon shape having five interior angles totaling 540 degrees.

Alternatively, a deformable stake (e.g., one or more of the deformable stakes 116 shown in FIGS. 1-4) may have different shaped gaps, different configuration(s) of optional features (e.g., tapered legs, thickness of a roof relative to the legs, width of the stake relative to a slot, etc.).

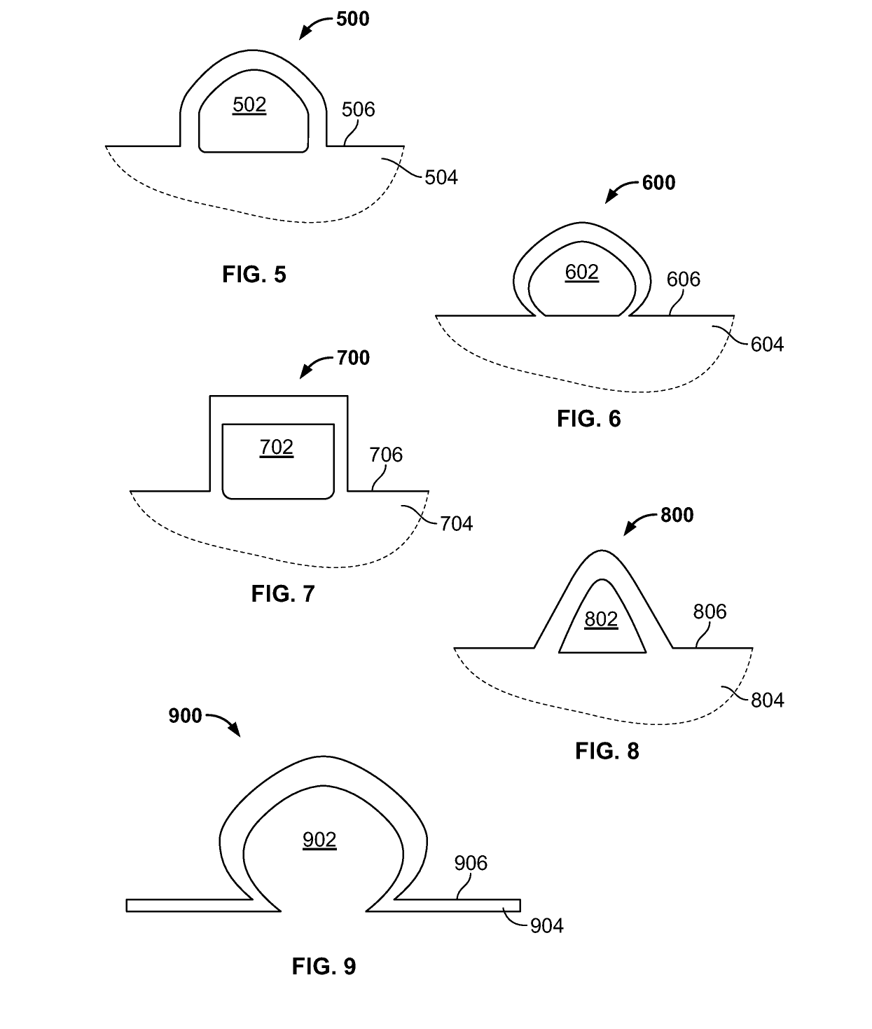

For example, FIGS. 5-10 illustrate various examples of deformable stakes 500, 600, 700, 800, 900, 1000 for inserting into any suitable slot including, for example, the slot 120 of FIG. 1, the slot of FIG. 11 (explained below), etc. As shown in FIGS. 5-8, each deformable stake 500, 600, 700, 800 extends from an edge surface 506, 606, 706, 806 of a component 504, 604, 704, 804, respectively, and includes two legs and a roof extending between the legs. Thus, the legs, the roof, and a portion of the edge surface 506, 606, 706, 806 of each component 504, 604, 704, 804 define a closed gap 502, 602, 702, 802, respectively, similar to the gap 118 of FIGS. 1 and 4. Therefore, after being crushed, the stakes shown in FIGS. 5-8 may be substantially flush with another component having the slot without requiring separate stopping device(s) as explained above.

In the example of FIG. 5, the deformable stake 500 includes legs and a curved roof having a substantially uniform thickness. Additionally, the gap 502 of FIG. 5 includes four sides (e.g., two substantially vertical extending sides, one curved side between the vertical extending sides, and a portion of the edge surface 506) and forms a “D” shape.

FIG. 6 illustrates the deformable stake 600 including tapered legs and a roof extending between the tapered legs. As shown in FIG. 6, the tapered legs and the roof include curved portions. The gap 602 of FIG. 6 forms a “CI” shape.

As shown in FIG. 7, the deformable stake 700 includes legs and a roof extending substantially perpendicular between the legs. Similar to FIGS. 1 and 4 explained above, the roof of FIG. 7 has a thickness greater than a thickness of each leg. The gap 702 of FIG. 7 includes four sides and forms a rectangular shape.

FIG. 8 illustrates the deformable stake 800 including legs and a curved roof extending between the legs. The legs and the curved roof of the deformable stake 800 have a substantially uniform thickness. The gap 802 of FIG. 8 includes three sides and forms a triangular shape.

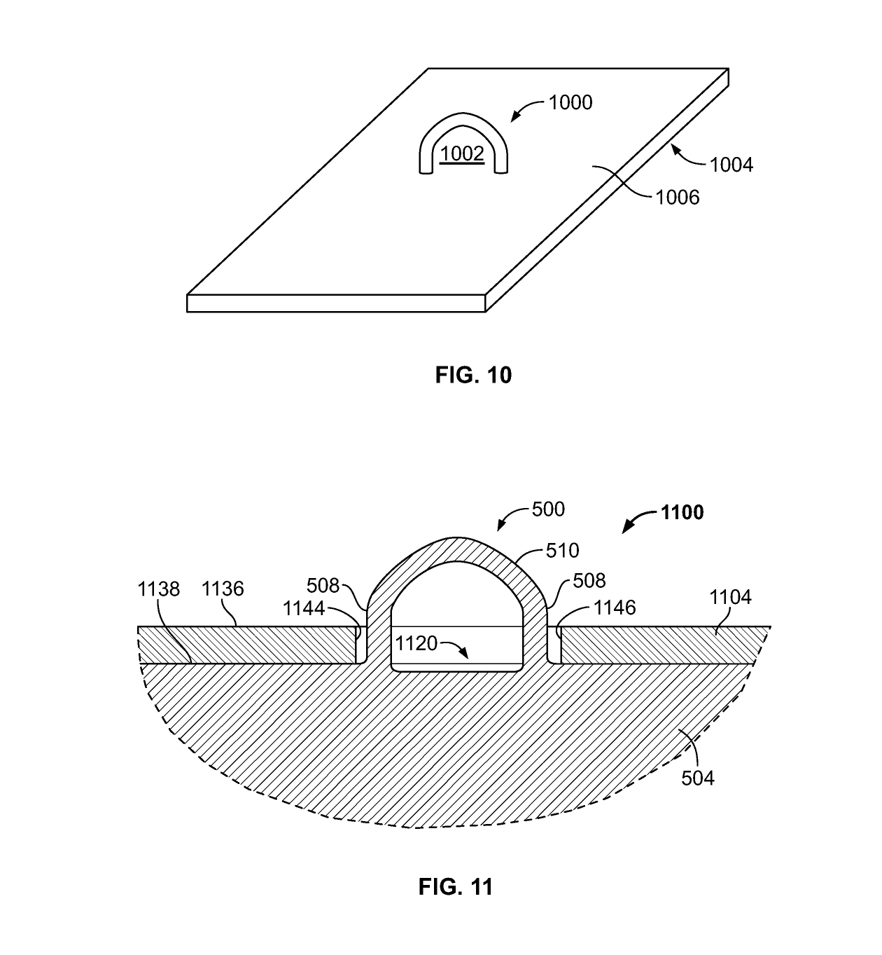

In the examples of FIGS. 9 and 10, each deformable stake 900, 1000 extends from a surface 906, 1006 (e.g., extending between edge surfaces) of a component 904, 1004, respectively. Thus, after inserting the stake 900, 1000 into a slot, the component 904, 1004 may extend substantially parallel with another component including this slot.

The deformable stake 900 of FIG. 9 is substantially similar to the stake 600 of FIG. 6. For example, the stake 900 includes tapered legs that may allow the legs to collapse with greater ease as explained above. The stake 900, however, includes a gap 902 not surrounded by a surface of the component 904. Thus, the gap 902 does not have a closed perimeter.

As shown in FIG. 10, the deformable stake 1000 of FIG. 10 is substantially similar to the stake 500 of FIG. 5, but extends from the surface 1006 between edge surfaces as explained above.

FIG. 11 illustrates another example assembly 1100 including the component 504 of FIG. 5, and a component 1104 defining a slot 1120. As explained above, the component 504 includes the deformable stake 500 having legs 508 and a curved roof 510. The legs 508 and the curved roof 510 have a substantially uniform thickness. Thus, the legs 508 of FIG. 11 do not include tapered portions.

The component 1104 is substantially similar to the component 104 of FIG. 1. The component 1104 of FIG. 11, however, does not include a beveled slot. Instead, the component 1104 includes inner surfaces 1136, 1138 and edge surfaces 1144, 1146 extending substantially perpendicular to the inner surfaces 1136, 1138.

Additionally, and as shown in FIG. 11, a width of the stake 500 (e.g., from the outside edge surface of one leg to the outside edge surface of the other leg) is less than a width of the slot 120 of the component 104. This may allow users, machinery, and etc. to insert the stake 500 into the slot 1120 with greater ease. In some cases, however, after inserting the stake 500 into the slot 1120, the components 504, 1104 may need to be temporarily held together before crushing, etc. the stake.

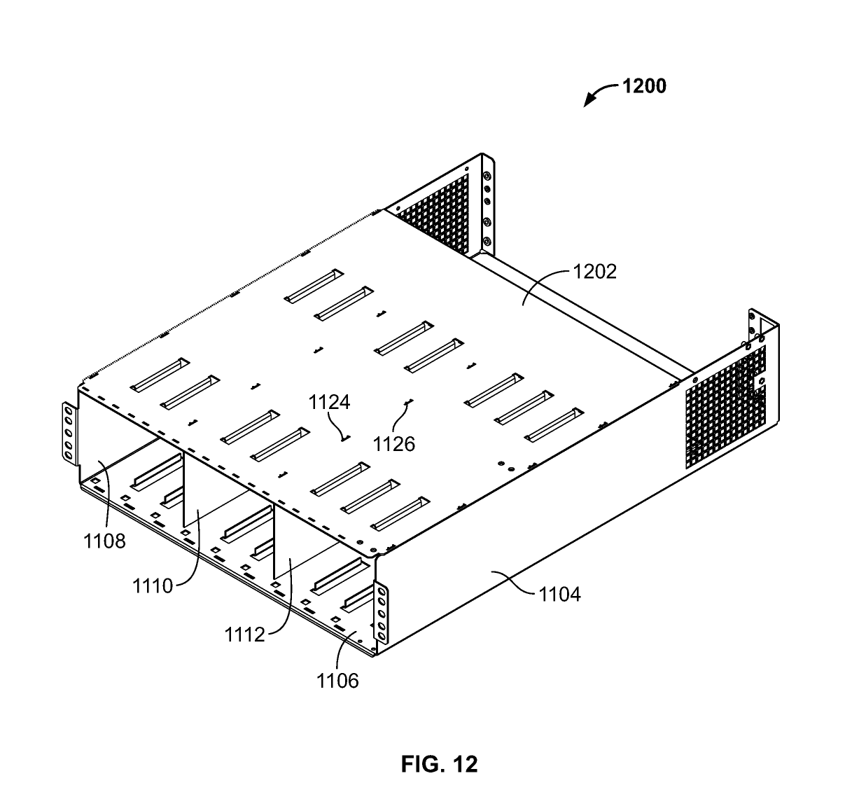

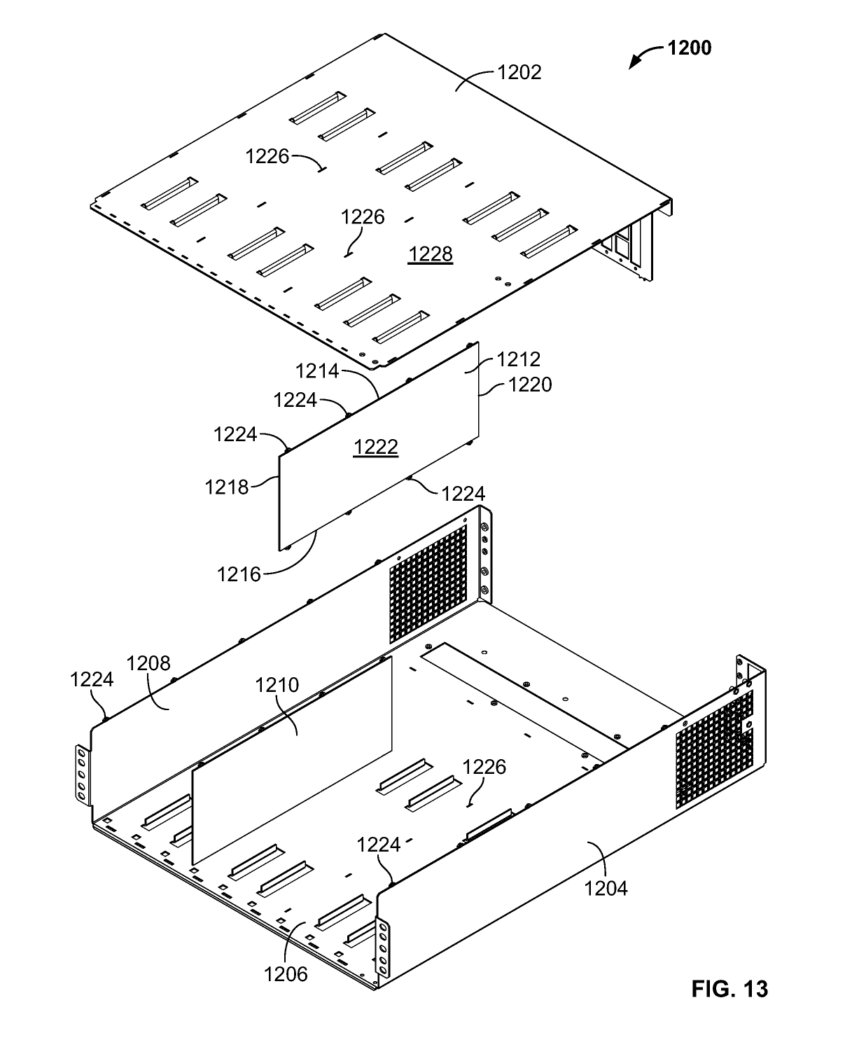

The components disclosed herein may be used to form a wide variety of structures including, for example, shelves, enclosures, cabinets, tables, etc. For example, FIGS. 12 and 13 illustrate a shelf 1200 including a cover 1202, a base 1206, and walls 1204, 1208, 1210, 1212 positioned between the cover 1202 and the base 1206. In the example of FIGS. 12 and 13, the walls 1204, 1208 are side walls for defining a portion of the exterior periphery of the shelf 1200 and the walls 1210, 1212 are partitions for separating particular areas, spaces, etc. in the shelf 1200.

As shown in FIGS. 12 and 13, the cover 1202, the base 1206, and the walls 1204, 1208, 1210, 1212 each include edge surfaces and inner surfaces extending between the edge surfaces. Each wall further includes one or more deformable stakes 1224 extending from two of the edge surfaces. The cover 1202 and the base 1206 each define one or more slots 1226 for receiving the deformable stakes 1224 as explained above.

For example, the wall 1212 includes edge surfaces 1214, 1216, 1218, 1220, inner surfaces 1222 extending between the edge surfaces, and one or more deformable stakes 1224 extending from the edge surfaces 1214, 1216. The cover 1202 includes edge surfaces and inner surfaces 1228 extending between the edge surfaces. The inner surfaces 1228 define the one or more slots 1226 (e.g., corresponding to the deformable stakes 1224). Thus, in the example of FIGS. 12 and 13, the cover 1202, the base 1206, and the walls 1204, 1208, 1210, 1212 may each be a component as explained above with reference to FIGS. 1-11.

As explained above, each deformable stake 1224 extends from edges surfaces of the walls and each corresponding slot 1226 is defined by inner surfaces of the base and/or the cover. Thus, when one or more stakes 1224 are inserted into the corresponding slots 1226, the walls and the base and/or the cover are substantially perpendicular to each other. Alternatively, one or more deformable stakes 1224 may extend from the inner surfaces of the wall(s), the cover 1202, and/or the base 1206. In such cases, the components may be substantially parallel to one another.

Any one (or all) of the deformable stakes 1224 of FIGS. 12 and 13 may include any of the deformable stakes disclosed herein and/or another suitable deformable stakes. For example, any one (or all) of the deformable stakes 1224 may include one or more of the stake features described above. Similarly, any one (or all) of the slots 1226 may include any of the slots disclosed herein and/or another suitable slot. For example, one slot 1226 may include beveled portions (e.g., the slot 120 of FIG. 1), another slot 1226 may not include beveled portions (e.g., the slot 1120 of FIG. 11), etc.

The shelf 1200 may be a shelf in a rack, an enclosure (e.g. a telecommunications equipment enclosure, a cabinet, etc.), etc.

The shelf 1200 and/or another structure including one or more features similar to those explained herein may be assembled by inserting one or more stakes of one component (e.g., the wall 1212) into corresponding slots defined by another component (e.g., the cover 1202), and then crushing, etc. the stakes to couple the components together. In some embodiments, the components may be temporarily held together before crushing, etc. the stakes (as explained above). In some cases, holding the components together may not be necessary if, for example, a width of a stake is larger than a width of a slot as explained above.

By employing one or more of the features described herein, deformable stakes (after being crushed, etc.) may not intrude into an internal volume of a structure (e.g., a shelf, an enclosure, a rack, etc.) and/or an outer perimeter of the structure. This may provide additional space inside and/or outside the structure otherwise not realized when conventional fasteners (having heads, elongated portions, etc.) are employed. Additionally, greater ease installing equipment into the structure, installing shelves and/or other components into the structure, etc. may realized due to the lack of protrusions (e.g., heads, elongated portions, etc. of conventional fasteners) extending from portions of the structure.

Additionally, and unlike conventional fasteners, additional components, hardware, etc. (e.g., nuts, washers, etc.) are not required. This may reduce manufacturing costs, increase usable space (as explained above), reduce manufacturing time, etc. Further, employing one or more of the features of the present disclosure allows users to couple components together in less time, at a lower cost, etc. than conventional methods (e.g., welding, etc.).

Further, due to one or more features of the present disclosure, a user may have to destroy a crushed stake to separate components coupled together as explained above. Thus, the joint retention of components coupled together using one or more features disclosed herein may be higher than conventional fasteners, welds, etc.

Although the figures illustrate a particular number of stakes and/or slots, any suitable number of each may be employed. For example, although FIG. 1 illustrates four stakes extending from each edge surface 106, 110, more or less stakes may extend from the edge surfaces, different edge surfaces, inner surfaces, etc. without departing from the present disclosure.

Additionally, the components and/or portions of the components disclosed herein may be formed monolithically. For example, the stake 116 (including its legs, roof, etc.) and/or the component 102 of FIGS. 1-4 may be formed monolithically. Alternatively, the legs, the roof, and/or the component may be formed separately and then coupled together.

Further, the components and/or the stakes disclosed herein may include any suitable materials. For example, the components and/or the stakes may include one or more metallic materials such as aluminum, aluminum alloys, steel (e.g., cold rolled steel, stainless steel, etc.), etc. Alternatively, other suitable materials, including, for example polymers, etc., may be employed without departing from the scope of the disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An assembly comprising:
a first component having a surface and a deformable stake extending from the surface and defining a gap between the surface and the deformable stake, the gap surrounded by the surface and the deformable stake; and
a second component defining a slot configured to receive the deformable stake for coupling the first component and the second component.

2. The assembly of claim 1 wherein the gap includes five sides.

3. The assembly of claim 1 wherein the slot includes a beveled slot.

4. The assembly of claim 1 wherein the deformable stake includes tapered legs.

5. The assembly of claim 1 wherein the surface includes an edge surface of the first component and wherein the deformable stake extends from the edge surface.

6. The assembly of claim 1 wherein the deformable stake includes a first leg, a second leg, and a roof extending between the first leg and the second leg and wherein the roof has a thickness greater than a maximum thickness of the first leg and a maximum thickness of the second leg.

7. The assembly of claim 1 wherein the deformable stake includes two legs and a roof extending between the two legs, wherein the slot has a width, wherein each of the two legs includes an outside edge surface and an inside edge surface opposing the outside edge surface, and wherein a maximum width between the outside edge surfaces of the two legs is greater than the width of the slot.

8. A shelf comprising the assembly of claim 1.

9. An assembly comprising:
a first component including a deformable stake having a first leg, a second leg, and a roof extending between the first leg and the second leg, each of the first leg and the second leg having an outside edge surface and an inside edge surface opposing the outside edge surface; and
a second component defining a slot having a width and configured to receive the deformable stake for coupling the first component and the second component,
wherein a maximum width between the outside edge surface of the first leg and the outside edge surface the second leg is greater than the width of the slot of the second component.

10. The assembly of claim 9 wherein the first component includes at least one edge surface and wherein the deformable stake extends from the at least one edge surface.

11. The assembly of claim 9 wherein the first component has a surface, wherein the deformable stake extends from the surface and defines a gap between the surface and the deformable stake, and wherein the gap is surrounded by the surface and the deformable stake.

12. The assembly of claim 11 wherein the gap includes five sides.

13. The assembly of claim 9 wherein the first leg and the second leg include tapered portions.

14. The assembly of claim 13 wherein the slot includes a beveled slot.

15. The assembly of claim 14 wherein the roof has a thickness greater than a maximum thickness of the first leg and a maximum thickness of the second leg.

16. A shelf comprising the assembly of claim 9.

17. An assembly comprising:
a first component having at least two edge surfaces, an inner surface extending between the at least two edge surfaces, and a deformable stake extending from one of the at least two edge surfaces and defining a gap between said one edge surface and the deformable stake; and
a second component defining a slot configured to receive the stake for coupling the first component and the second component.

18. The assembly of claim 17 wherein the deformable stake includes a first leg, a second leg, and a roof extending between the first leg and the second leg and wherein the roof has a thickness greater than a maximum thickness of the first leg and a maximum thickness of the second leg.

19. The assembly of claim 17 wherein the gap includes five sides.

20. The assembly of claim 17 wherein the deformable stake includes two tapered legs and a roof extending between the two tapered legs.
